(19) United States
(12) Patent Application Publication
(10) Pub. No.: US 2017/0323292 A1
(43) Pub. Date: Nov. 9, 2017

(54) METHODS AND SYSTEMS FOR MAKING PAYMENTS

(71) Applicant: MASTERCARD INTERNATIONAL INCORPORATED, PURCHASE, NY (US)

(72) Inventors: Asheesh Agarwal, Ahmedabad (IN); Kshitiz Saxena, Mathura (IN); HIRALEE MALAVIYA, Vadodara (IN); NEHA SHAH, Vadodara (IN); GIREESH PUNJOT, Dungarpur (IN)

(21) Appl. No.: 15/590,197

(22) Filed: May 9, 2017

(30) Foreign Application Priority Data
May 9, 2016 (SG) 10201603667W

(51) Int. Cl. G06Q 20/36; G06Q 20/10; G06Q 20/34; G06Q 20/20; G06Q 20/12; G06Q 20/02; G06Q 20/32

(52) U.S. Cl. CPC G06Q 20/3674; G06Q 20/102; G06Q 20/105; G06Q 20/20; G06Q 20/351; G06Q 20/023; G06Q 20/322; G06Q 20/12

(57) ABSTRACT

A computer-implemented method and computer system are proposed for assisting a consumer associated with a plurality of payment cards. When the consumer wishes to make a payment transaction, a computer system with access to information about the payment cards and access to at least one consequence database storing information relating to consequences of the making payment using the payment cards, determines consequences of making the payment using each of a plurality of the payment cards. According to the determined consequences, the computer system makes an automatic selection of one of the payment cards to use for the purchase. The computer system's selection may be presented to the consumer as a proposal. Upon the consumer accepting the proposal, the payment transaction is performed using the selected payment card.

### FIELD OF THE INVENTION

The present invention relates to computer systems and computer-implemented methods for making payments using payment cards.

### BACKGROUND OF THE INVENTION

Many online payments to an online merchant are made by a payment card holder entering their payment card details into a webpage supported by a merchant server operated by the user. This system has a number of disadvantages. First, the payment card holder may be unwilling to divulge his or her credit card details to the online merchant. Second, the process of entering the card details is time-consuming.

To address these problems, it is known to provide a digital wallet system. For example, MasterCard International Incorporated provides the MasterPass® system. A card holder sets up one or more “digital wallets” on a wallet-hosting server (here referred to as a “digital wallet server”). There are two forms of digital wallet server. One is a server operated by an organisation which is not itself a card issuer, but which is a trusted partner of the card issuer (in existing implementations, the organisation may be MasterCard International Incorporated itself). The other form is a server operated by a card issuer (conventionally, a wallet on such a server is referred to as a “partner-hosted wallet”). Both the server(s) operated by MasterCard International Incorporated, and the servers operated by card issuers use the same APIs (developed by MasterCard International Incorporated), so that the user sees no difference in using the two forms of wallet-hosting server.

A card holder registers his or her payment card(s) with a digital wallet. Having done this, the card holder can interact with a participating online merchant. At the check-out stage, the online merchant displays a button on the merchant website which the card holder can click on in order to make a payment using the card holder's digital wallet. The online merchant then redirects the user to a “switch” operated by MasterCard International Incorporated. Using a cookie located on the card holder's computer, the “switch” is able to determine which wallet-hosting server hosts a wallet associated with the card holder. The switch then establishes a connection between the card holder's computer and the appropriate wallet-hosting system, which presents the card holder with a MasterPass sign-in page (e.g. as a pop-up window), where there is an authentication process (e.g. entry of a pre-agreed password). This log-in process may use the same login credentials (e.g. password) which the user also uses to obtain access to other online banking activities.

Following the authentication process, if more than one digital wallet has been created for a given card holder, the card holder chooses the digital wallet he or she would like to use. If more than one payment card is associated with the digital wallet, he or she chooses one of the payment cards. He or she may further confirm a shipping address he or she wishes to use (e.g. by selecting from previously entered addresses). The wallet-hosting system then securely transfers the card holder's payment and shipping information to the online merchant's domain. The merchant's domain submits the card holder's payment information to the acquiring bank, for a separate authorization process in which the acquiring domain communicates with the issuing bank to ask the bank to authorize the transaction. Thus, the card holder is not required to enter their card details (except at the stage of initially registering with the wallet-hosting system), and the online transaction process is streamlined with only a single redirection, and consistent branding for the entire payment process, irrespective of the online merchant.

The MasterPass system has been further extended to in-store payments using a mobile communication device associated with a card holder. Upon the card holder wishing to make a payment, an application on the card holder's mobile device communicates with a point-of-sale (POS) terminal operated by a merchant. When the card holder wishes to make a payment using the digital wallet, a communication path is established between the mobile device and the server operating the digital wallet. The mobile device sends details of the intended transaction (e.g. the transaction value, and an ID number of the merchant) to the server. As for the online shopping use of MasterPass described above, if more than one digital wallet has been created for a given card holder, the server asks the card holder to choose the digital wallet he or she would like to use. If more than one payment card is associated with the digital wallet, the server asks the card holder to choose one of those payment cards. Upon the user choosing, the server passes details of the selected card to the mobile device which forwards them to the POS terminal. The POS terminal takes a payment in the same way in which it would handle a payment transaction using a physical payment card: the details of the selected card the POS terminal receives from the mobile device, and the details of the transaction are passed to an acquirer bank associated with the merchant in the form of a cryptogram. The acquirer bank seeks authorization for the transaction from the issuer bank of the payment card, and, if the transaction is authorized, the issuer bank debits the payment amount (optionally plus a handling charge) to a payment account associated with the selected payment card, and the acquirer bank credits the payment amount (optionally plus a handling charge) to the payment account of the merchant. At a subsequent time, the issuer bank makes a payment to the acquirer bank, for example as part of a clearing operation.

Typically, the details which the server passes to the mobile device are a “token”, which is an encrypted form of the personal account number (PAN) of the card (typically a 16 digit number which is printed on the payment card if it has physical form). The token is specific to the mobile device. It is generated according to a technology called MDES (MasterCard Digital Enablement Service).

There is a continued need to enhance a digital wallet system, to provide further advantages to the card holder.

### SUMMARY OF THE INVENTION

The present invention aims to provide new and useful computer systems and computer-implemented methods for making payments using payment cards.

In general terms, the invention proposes that, when a consumer associated with a plurality of payment cards wishes to make a payment transaction (a purchase to a merchant), a computer system with access to information about the payment cards and access to at least one consequence database storing information relating to consequences of the making payment using the payment cards, determines consequences of making the payment using each of a plurality of the payment cards. According to the determined consequences, the computer system makes an automatic selection of one of the payment cards to use for the purchase.

Optionally, the computer system's selection may be presented to the consumer as a proposal before it is used for the purchase. Upon the consumer accepting the proposal, the payment transaction is performed using the selected payment card.

The computer system may use one or more rationales to decide which payment card to select. The consequence database stores information for use by the computer system to determine the appropriateness of each of the payment cards according to these rationale(s). If there are multiple rationales, the computer server determines which of the rationales is most compelling.

First, one of the payment card selection rationales may be based on offers made to the consumer if a given payment card is used. Specifically, the computer system may use information about an offer (such as a discount, a cashback, or a reward) the merchant makes if the purchase is made using a payment card meeting one or more criteria relating to the payment transaction and/or the payment card. For example, the criteria may include a criterion that the payment transaction is for more than a certain value, and/or is within a certain time window; and/or the criteria may include a criterion that the payment card is of a certain type, or is issued by a certain issuing bank, or is supported by a certain payment network. The computer system determines if the criteria are met for each of the consumer's payment cards, and accordingly determines what offer is available if that card is used for the payment transaction. One of the payment card selection rationales may be based on the corresponding offers. In a simple case, for example, the computer system could select the payment card for which the value of the offer was maximal. In other words, it could be based on the savings/rewards the consumer could receive immediately.

Secondly, one of the payment card selection rationales may be based on loyalty points. Specifically, the server may use information about loyalty points the consumer would earn in a loyalty program by using a certain payment card. The consequence database may include information about how many loyalty points the consumer has already accumulated in the program.

Thirdly, one of the payment card selection rationales may be based on payment card usage requirements. Specifically, the server may use information about card usage requirements of the payment cards, and the consequences of not using the payment card according to the usage requirements. For example, if a certain payment card requires that the payment card is used according to certain conditions to avoid at least one negative consequence (e.g. if the consumer has to use the payment card to make payment totalling above a certain threshold by a certain date to avoid the card being cancelled or a penalty charge being made), then the server may take these consequence(s) into account.

Note that these three payment card selection rationales are such that the payment card recommendation is unbiased as between different payment cards, and entirely in the consumer's best interests. Note also that this list of possible rationales is not exclusive, and also that more than one of the rationales can be used: in effect a further rationale can be developed based on any combination of a plurality of the rationales explained above, for example such that the consequences based on both offers and loyalty points, so that the best available card option can be recommended based on both these factors.

In any of these possibilities, the computer system may additionally use information about the consumer's past transactions.

For example, the computer system may use the information to develop a model of the consumer's behaviour, which permits the computer system to make a probabilistic prediction about the consumer's future payments. These could be used in calculating the consequences of using a certain payment card.

For example, if the computer system predicts that the consumer will, with a certain likelihood, make a further purchase from the same merchant during a certain future time period, this may have a bearing on the value the consumer is likely to receive from the merchant's offer(s).

In other words, the computer system may suggest a payment card to use based on savings/rewards the consumer may make during a time period extending into the future, e.g. the total savings/rewards during a certain number of weeks, months or even years in the future, based on a probabilistic prediction of the consumer's behaviour during that future time period.

In another example, if the computer system predicts that the total transactions the consumer will make in the future are beyond a certain level, this may have a bearing on whether the consumer will be able to make sufficient payments using a certain one of the payment cards to meet the card usage requirements for that payment card. If the computer system predicts that a given consumer will have plenty of future possibilities to use the payment card to meet the card usage requirements, then it is less likely to suggest that the payment card is used for the present transaction.

Note that the computer system may determine whether sufficient historic information is available to make a prediction about the consumer's future payments. If this information is not available, e.g. because the consumer is a new customer, then the consequences may be calculated without taking into account predictions of future behavior e.g. based on the offers which the merchants makes only in relation to the present transaction. Alternatively, the consequences may be calculated using a prediction of the consumer's future behavior which is made based on historic information describing past transactions by “similar consumers”, that is other consumers for whom historic information is available and who meet one of more similarity criteria indicative of being similar to the consumer, according to whatever data relating to the consumer may exist. For example, if the consumer is known to have one or more demographic properties (e.g. gender; an age within a certain age range; or an income bracket), the similar consumers may be consumers who have one or more of these demographic properties.

The computer system may use the information of past transactions in several ways to make the probabilistic prediction. One possibility is for the computer system, e.g. as card transactions are made by the consumer, to accumulate a database of historic data describing those transactions. When the consumer wishes to make a new transaction using one of the payment cards, the computer system may use information about the new transaction and the historic data, in combination with information from the consequences database, to predict the consumer's future behavior probabilistically.

Alternatively, the computer system may form an adaptive model of the payment transaction behavior of each consumer, and update the adaptive model successively for successive payment transactions. For example, the model may be updated whenever the consumer requests a new payment transaction, or following successful completion of a payment transaction. In this case, the computer system may not need a database of historic data: in effect, this information is embedded in the adaptive model. In other words, if the adaptive model is defined by model parameters, then the model parameters encode the historic data, such that the model generates data indicative of the payment behavior of the consumer.

Note that the data indicative of the payment behavior of the consumer may be used in additional ways. For example, the computer server may provide it (e.g. sell it) to merchants and/or payment card issuers to provide them with consumer intelligence. The data for multiple consumers could be combined statistically. This may both anonymize it, and make it possible to discover trends in consumer transaction behavior. The data would be useful to help merchants understand the purchases consumers have made from other merchants, and develop retail strategies accordingly. Furthermore, the data might help merchant and payment card issuers to develop offers in coalition.

In one example, the computer system may be a computer system which implements a digital wallet. In another example, combinable with the first, the computer system is a computer system operated by a payment network. In a further example, the computer system may be a merchant server, or conceivably even a point-of-sale terminal. Embodiments of these examples may be implemented with no change to the existing payment transaction patterns.

The invention may be expressed as a computer implemented method, or as a computer system arranged to perform the method, such as one including a processor and a data storage device storing program instructions operative, when performed by the processor, to cause the processor to perform the steps of the method.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC (near field communication)-enabled devices, and/or computers. Furthermore, the “payment card” may exist only as a data structure (i.e. without physical existence), which is registered with a digital wallet or cloud wallet.

### BRIEF DESCRIPTION OF THE DRAWINGS

An embodiment of the invention will now be described for the sake of example only with reference to the following figures, in which:

FIG. 1 shows schematically a computerized network including a server which is an embodiment of the present invention.

FIG. 2 shows the structure of a module of the server of the computerized network of FIG. 1.

FIG. 3 is a flow diagram of steps performed by the computerized network of FIG. 2 in a method which is an embodiment of the invention.

FIG. 4 shows information flow during the method of FIG. 3.

FIG. 5 is a flow diagram of steps performed by the computerized network of FIG. 2 in another method which is an embodiment of the invention.

FIG. 6 shows information flow during the method of FIG. 5.

FIG. 7 shows schematically a second computerized network including a computer server which is an embodiment of the invention.

FIG. 8 is a flow diagram of steps performed by the computerized network of FIG. 7 in another method which is an embodiment of the invention.

FIG. 9 shows the structure of a server system which may be used in the computerized networks of FIGS. 1 and 7.

FIG. 10 shows the structure of a portable communications device which may be used in the computerized networks of FIGS. 1 and 7.

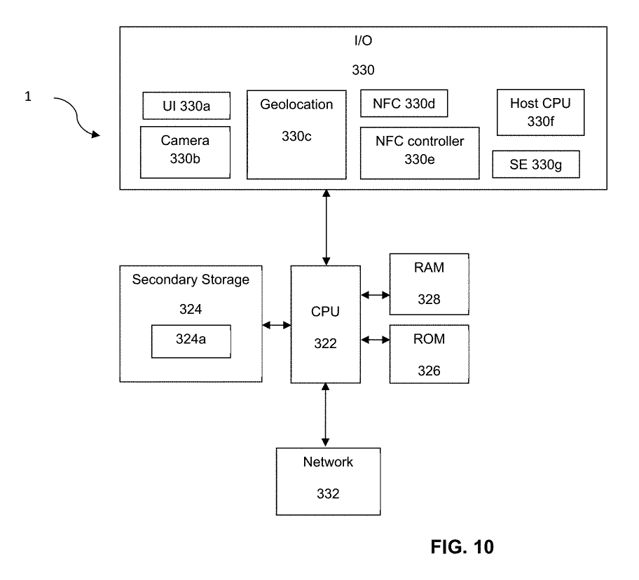

### DETAILED DESCRIPTION OF THE EMBODIMENTS

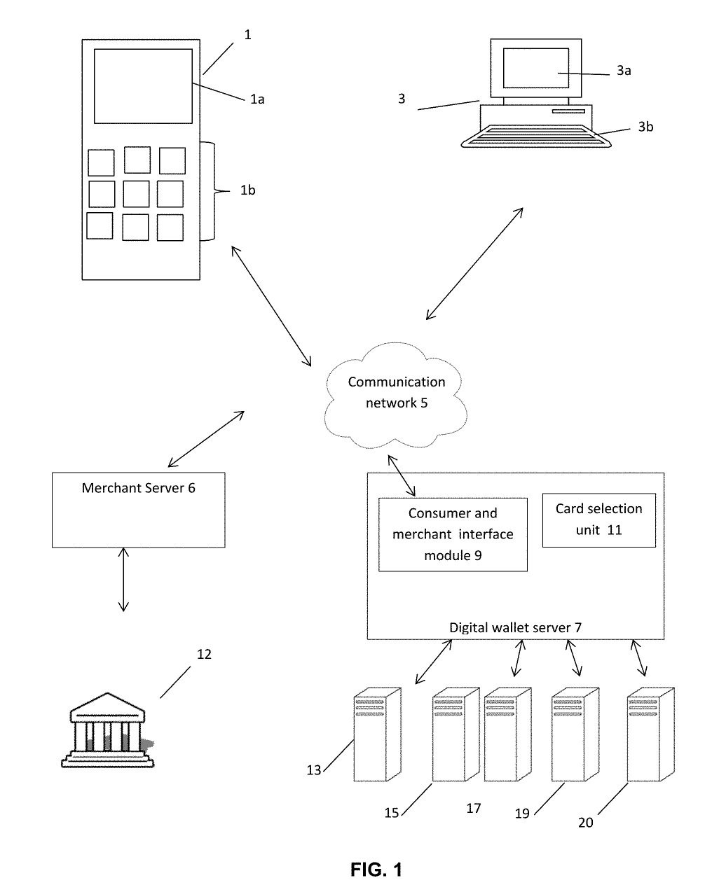

Referring firstly to FIG. 1, a computerized system is shown including a digital wallet server 7 which is an embodiment of the invention. The system permits a card holder (here a “consumer”) who is associated with one or more payment cards to make a purchase from an online merchant. Although the embodiment is explained below with reference only to a single consumer, in a typical embodiment a large number of consumers (e.g. at least 100) may use the embodiment at any given time.

The consumer operates a communication device which may be either a mobile device 1 or a personal computer (PC) 3. Both are shown in FIG. 1, but in reality the consumer will use one or the other. The communication device 1, 3 includes a screen 1a, 3a and one of more data input devices 1b, 3b. The communication device 1, 3 is operative to communicate with a communication network 5 such as the internet. The merchant operates a merchant server 6 which is also connected to the internet. The consumer uses the communication device 1, 3 to select one or more products (a term which is used here to includes goods and/or services) using the merchant website.

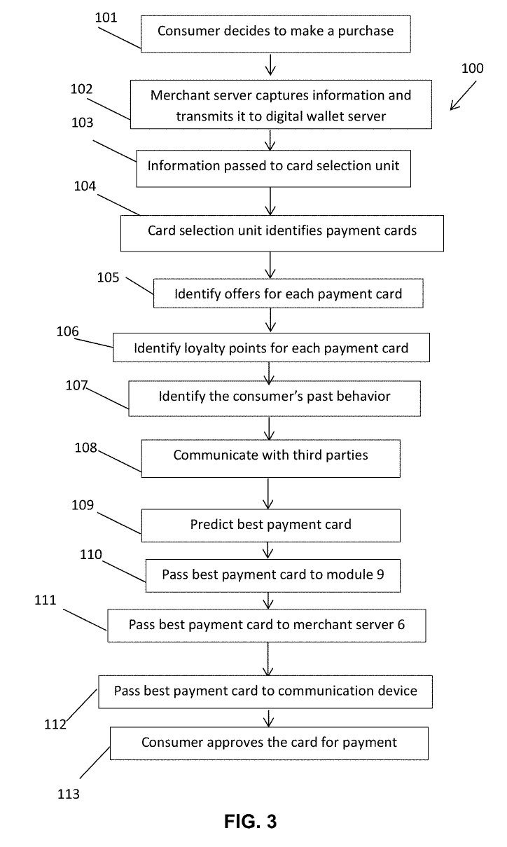

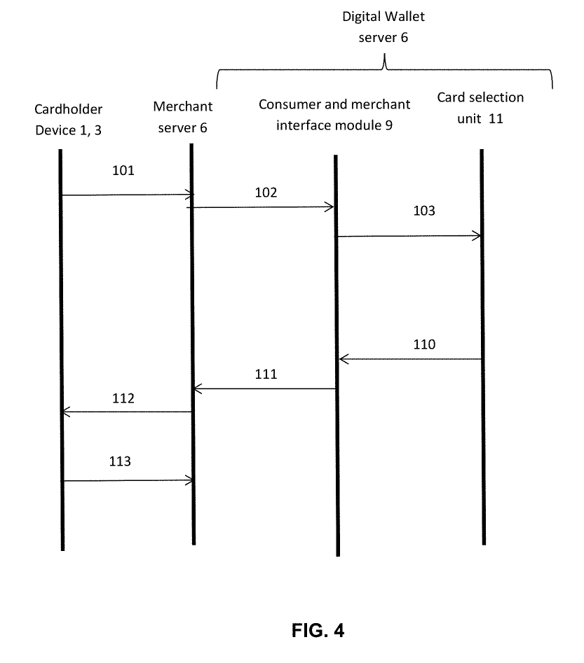

As described below, upon the card-holder wishing to make a purchase, the card-holder issues a command to the merchant server 6 to initiate a process 100 (explained below with reference to FIGS. 3 and 4) which is an embodiment of the present invention. For example, the merchant server 6 may control the communication device 1, 3 to display an icon which the consumer can click to initiate the process. The result of the process is to select a payment card for the consumer which will be used in a payment transaction. The merchant server 6 will perform the transaction according to the conventional procedure described above, involving an acquirer bank server 12.

Certain steps of the process 100 are performed by a digital wallet server 7. Note that in other embodiments, the function of the digital wallet server 7 may be split across multiple servers. The digital wallet server 7 is operative to communicate with the communication device 1, 3 and the merchant server 6. The digital wallet server 7 comprises a consumer and merchant interface module 9 for providing an interface to the communication device 1, 3, and to the merchant server 6.

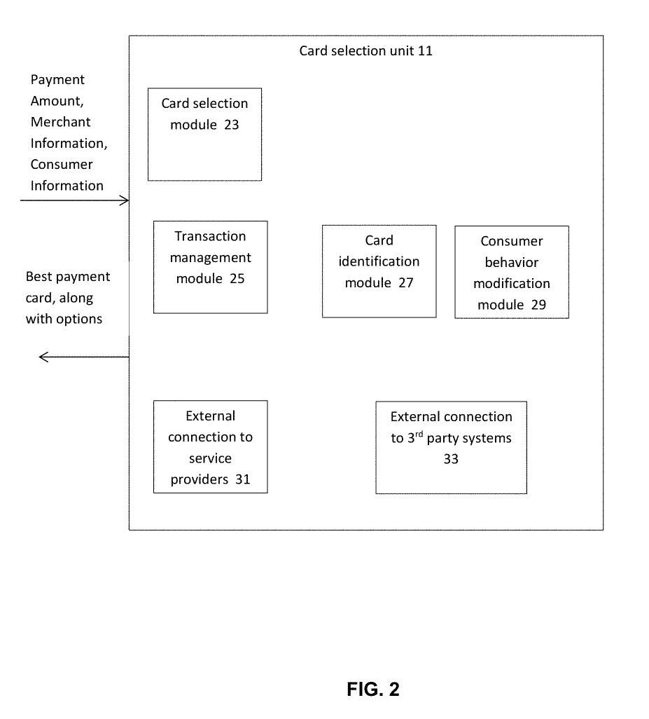

The digital wallet server 7 further includes a card selection unit 11. The structure of the card selection 11 is explained in more detail below with reference to FIG. 2.

The digital wallet server 7 is optionally able to communicate with other computer systems 13, 15, 17, 19, 20. These include a tokenization system 13, typically associated with a payment card issuer, for generating a token to transmit to the consumer devices 1, 3 or to the merchant server 7.

The digital wallet server 7 is also able to communicate with an offer management system 15 for storing offers made by merchants. These offers may be discounts and/or rewards which merchants offer if a purchase is made with a payment card having certain characteristics.

The digital wallet server 7 is also able to communicate with a loyalty management system 17 which stores details of loyalty programs, of which the consumer may be member.

The digital wallet server 7 is also able to communicate with a transaction history management system 19. This is typically operated by a payment card issuer.

The digital wallet server 7 is also able to communicate with a Payment Card Management System 20. This is a known entity responsible for managing all types of payment cards and payment card programs. The card selection unit 11 interfaces with system 21 to get consumer card related information.

Some or all of the tokenization system 13, offer management system 15, the loyalty management system 17, and the transaction history management system 19 are typically in contact with (e.g. obtain information from) the merchant operating the merchant server 6, and/or with service providers, and/or with further offer providers, and optionally also with third party systems such as other merchants.

Turning to FIG. 2, the structure of the card selection unit 11 is shown. It includes a card selection module 23, a transaction management module 25, a card identification module 27, and a consumer behavior modification module 29. It also includes a module 31 for providing a communication interface to external service providers, and a module 33 for providing a communication interface to third party systems.

Turning to FIG. 3, a method 100 performed by the embodiment of FIG. 1 is shown. The flow of information in each of these steps is shown in FIG. 4, where the numbers on the arrows correspond to the steps of FIG. 3.

In step 101, the consumer who has used the communication device 1, 3 to select product(s) at the online merchant website supported by the merchant server 6, decides to make the payment for the product(s). He or she enters a command into the consumer interface of the communication device 1, 3, which transmits a command to the merchant server 6 to make a payment using a digital wallet which is supported by the digital wallet server 7. Note that optionally, there may be other digital wallet servers (not shown), e.g. operated by other payment networks, some or all of which may have the same structure as the digital wallet server 7; if the consumer selects one of those digital wallets, the merchant server 6 would contact the corresponding server, and perform a method having some or all of the steps of method 100.

In step 102, a processing module embedded within the merchant website captures consumer information, the payment amount and merchant information and sends it to the consumer and merchant interface module 9 of the digital wallet server 7.

In step 103, the consumer and merchant interface module 9 of the digital wallet server 7 sends all the captured information to the card selection unit 11. At this point there is typically a consumer authentication step, as for a conventional digital wallet, using digital wallet identification information.

In step 104, the card identification module 27 identifies the payment cards associated with the consumer. It is here assumed that there are a plurality of such payment cards. The consumer behavior modification module 28 is associated with an adaptive system which is used to predict future behavior by the consumer, and the adaptive system may be modified based on the information received in step 103.

The card selection unit 11 identifies the best payment card to be used in the transaction for the requesting consumer according to the following steps.

In step 105, the transaction management module 23 communicates with the offer management system 15 (using the module 31) to identify the offers available for consumer's payment cards. In a variation of the embodiment the offer management system 15 is replaced by an internal module of the card selection unit 11.

In step 106, the transaction management module 23 communicates with the loyalty management system 17 (using the module 31) to calculate the loyalty points for a transaction based on loyalty cards linked with consumer's profile and/or consumer's payment cards. In a variation of the embodiment the loyalty management system 17 is replaced by an internal module of the card selection unit 11.

In step 107, the transaction management module 23 communicates with the Transaction History management system 19 (using the module 31) to identify the consumer's behavior based on his or her past transactions. Optionally, this may include making a prediction about the consumer's future behavior, for example using a component of the consumer behavior management module 29. This component may be an adaptive model.

In optional step 108, the transaction management module 23 may use the module 33 to communicate with one or more third parties. These may include other banks, from which the transaction management module 23 may obtain details of further payment options and optionally offers associated with them, so as to identify other payment options which may be more beneficial than all the pre-registered payment cards. It may also communicate with the third party merchants to obtain information about one or more offers made by the third party merchants to supply similar goods to those covered by the payment transaction.

In step 109, the card selection module 23, based on all the information captured in steps 105-107 (and step 108 if performed), predicts the best payment card of the digital wallet to be used for the requested transaction (if step 108 was performed, this may take into account other payment options for which information was obtained). Two examples of the computing operation this may involve are given below. The card selection module 23 will take into consideration various factors such as, but not limited to the past consumer behavior, transaction time, various promotional events etc. The system will always try to make sure that the consumer is getting the best deal out of his payment transaction. The past consumer behavior may be encoded by the adaptive system maintained by the consumer behavior modification module 29.

In step 110, the card selection module 23 passes the best payment card to the consumer and merchant interface module 9. If step 108 was performed, this may include passing on data describing the other payment options for which information was obtained and their associated offers, and/or the third party merchant offers.

In step 111, the consumer and merchant interface module 9 forwards the data to the payment portal of the merchant website with the best payment card for the requested transaction. If step 108 was performed, this may include passing on data describing the other payment options for which information was obtained and their associated offers, and/or the third party merchant offers.

In step 112, the merchant server 6 sends instructions to the communication device 1, 3 to display the best payment card. If step 108 was performed, this may include displaying data describing the other payment options for which information was obtained and their associated offers, and/or the third party merchant offers.

In step 113, the consumer sees and (typically) chooses the payment card suggested by the portal for making the payment. After this confirmation, the consumer will be redirected to merchant website for continuing with his payment, according to a conventional method, using the selected payment card. If step 108 was performed, the consumer may alternatively select one of the other payment options for which information was obtained, and/or one or more of the third party merchant offers.

Note that in the embodiment of FIG. 1, if the consumer chooses to directly enter the payment card details into the payment interface of the merchant website, then the digital wallet server 7 cannot help him to select the best payment card for the transaction. However, in a variant of the embodiment, the merchant server 7 includes a smart client module having the same structure as the card selection unit 11 of FIG. 2, and performing the same function. Upon the consumer inputting data identifying him/herself, or a payment card associated with him/herself, this smart client module will ask the consumer for his digital wallet identification information so that the card selection unit 11 can perform steps identical to steps 104-109, and the merchant server 6 can then perform step 112.

In one possible variant of the method above, the merchant server 6 might be integrated with the digital wallet server 7 so that the user in step 101 can select products using a single merchant/digital wallet server. In this case, the steps of passing data between the merchant server 6 and the digital wallet server 7 could be omitted, and the user would just make product selection(s) by using the communication device 1, 3, to communicate with the combined server.

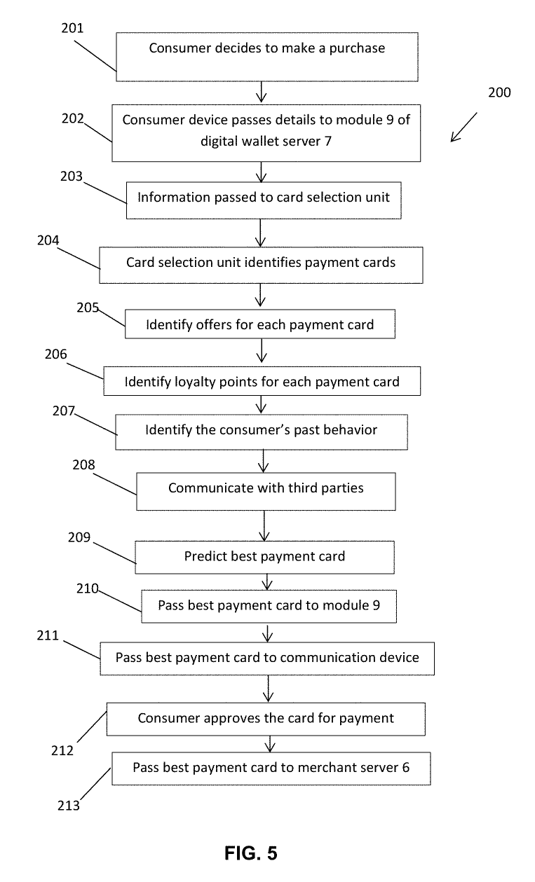

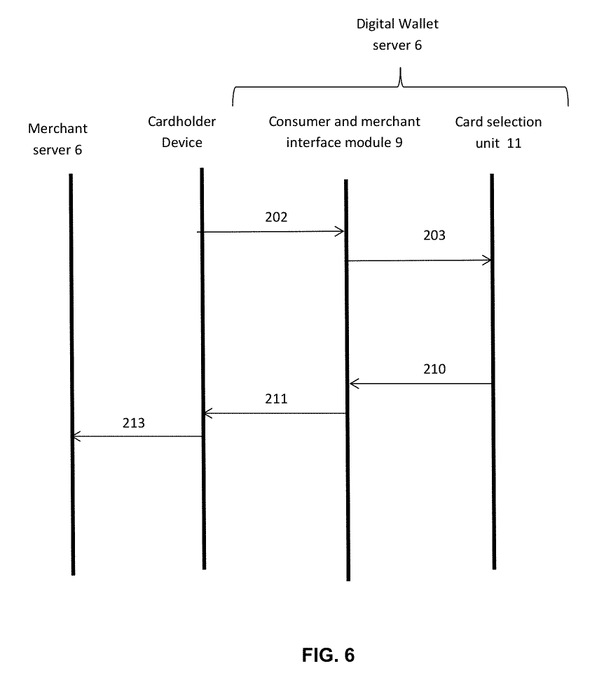

A method 200 which is a variant of method 100 is shown in FIG. 5. The method 200 may also be performed using the communication network of FIG. 1, but the flow of information is different. In this case, the communication device 1, 3 is provided with a software application, such as an application supplied by a merchant (in a variation, the software application may be supplied by another party, such as an issuer bank, but offers products supplied by one or more merchants). In this case, the path of communication of data may be as shown in FIG. 6.

In step 201 the consumer makes a product selection using the software application. In step 202 the application on the communication device 1, 3 directly contacts the module 9 of the digital wallet server 7, and transmits to it data characterizing the payment, such as the transaction amount and the merchant offering the selected product(s).

Steps 203-210 are the same as steps 103-110 of method 100 respectively. In step 211, the module 9 of the digital wallet server 7 passes the selected payment card to the application on the communication device 1, 3 as a recommendation. In step 212, the application displays the recommendation to the consumer, and the consumer confirms that the selected payment card is to be used. In step 213, the application on the communication device 1, 3 passes details of the order, including the selected payment card, to the merchant server 6. The merchant server 6 implements the order.

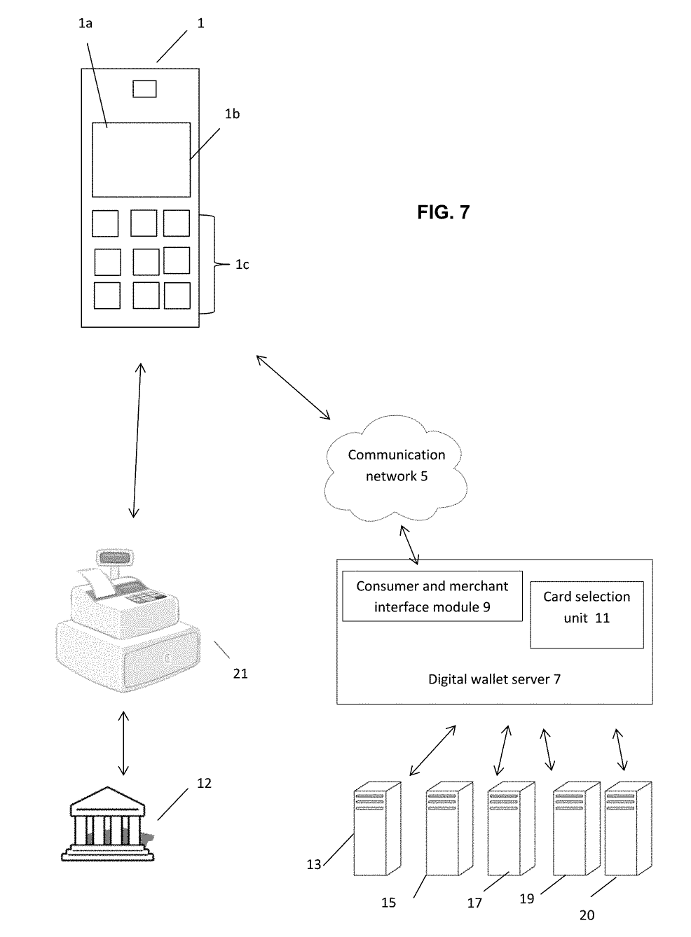

We now turn to FIG. 7 which shows a computerized network which is a second embodiment of the invention. Many of the elements of the computerized network of FIG. 7 are identical to that of FIG. 1, and they are given the same reference numerals. However, in contrast to the computerized network of FIG. 1, the computerized network of FIG. 7 contains a point-of-sale (POS) terminal 21 provided at a retail location associated with the merchant.

The POS terminal 21 is, like the merchant server 6 of FIG. 1, in communication with the acquirer bank server 12. The POS terminal 21 may further have a communication interface (e.g. a NFC interface, QR (quick response) code reader, QR code scanner etc.) to communicate with the card holder's mobile communication device 1, when the consumer makes a purchase.

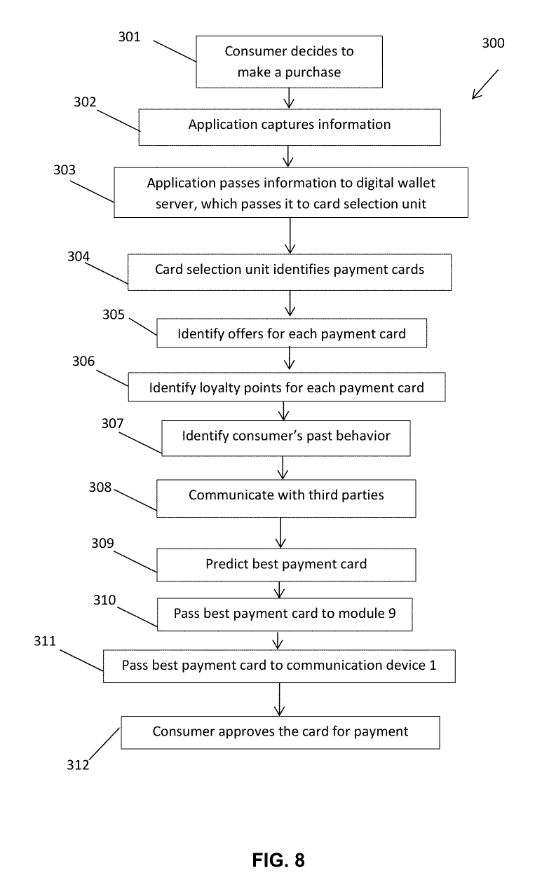

The method 300 performed by the computerized network of FIG. 7 is similar to the methods 100 and 200, and is illustrated in FIG. 8.

In step 301, the consumer presents the communication device 1 to the point-of-sale terminal 21 to make a payment.

In step 302, an application installed on communication device 1 captures from the point of sale terminal 21 the payment amount and other merchant information if available for merchant identification. Otherwise the application can obtain this information from the consumer, or use a GPS function of the communication device to find its geolocation.

In step 303, the application transmits the information obtained in step 302 to the module 9 of the digital wallet server 7. If the captured data includes a geo-location, the card selection unit 11 can use the geo-location to identify the merchant store (e.g. using a database in the digital wallet server 7). The digital wallet server passes the information to the card selection unit.

Steps 304-310 are the same as steps 104-110 respectively.

In step 311, the digital wallet server 7 will respond back to the application with the best payment card for the requested transaction and will also list down other payment options along with their associated offers.

In step 312, the consumer sees and chooses the payment card suggested by the application for making the payment. The payment procedure may then proceed, in a conventional fashion, including the communication device 1 passing details of the payment card (or a tokenized version of those details obtained from the digital wallet server 7) to the POS terminal 21.

We now present two examples of how the card selection unit 11 behaves in real time under different circumstances when implementing either of the methods 100, 200 or 300. The database tables mentioned in below examples reference a subset of data elements which are stored by business entities (Payment Network Provider, Offer Management System, Merchant, Service Provider etc.). There may be more data available in certain cases based on who is providing this implementation.

### Example 1

Sam has two credit cards, here called card 1 and card 2. Sam takes his girlfriend to a restaurant and he is not sure which payment card to use for making payment of $65 towards his bill/check.

Table 1 shows a payment card program table, and Table 2 shows the offer table.

TABLE 1
Payment Card Program Table

| Id | Payment Program Name | Description |
|---|---|---|
| 90001 | Card 1 | <General program description> |
| 90002 | Card 2 | <General program description> |

TABLE 2
Offer Table

| | | Associated | | | | |
|---|---|---|---|---|---|---|
| | | Payment Program | Expiry | Discount | | |
| Id | Offer Title | Id | Date | Type | Discount | MCC |
| 10001 | $5 off on all | 90001 | Jan. 30, | Flat | 5 | 5411 |
| | transactions | | 2016 | | | |
| 10002 | 10% off on all | 90001 | Jan. 30, | Percentage | 10 | 5812 |
| | transactions above $50 | | 2016 | | | |
| 10003 | 15% off on all | 90002 | Mar. | Percentage | 15 | 5691 |
| | transactions above | | 30, 2016 | | | |
| | $100 | | | | | |

Here the card selection unit 11 would suggest to Sam that he uses card 1 to make the payment, to take the benefit of 10% off on his bill/check.

### Example 2

Sam has two credit cards, here called card 1 and card 2. Sam goes to a clothing store to buy clothes for himself. He is standing at the payment counter to pay a bill of $100. He does not know which credit card to use to get a good deal.

The payment card program table in this case is the same as Table 1. The offer table is as shown in Table 3.

TABLE 3
Offer Table

| | | Associated | | | | |
|---|---|---|---|---|---|---|
| | | Payment Program | Expiry | Discount | | |
| Id | Offer Title | Id | Date | Type | Discount | MCC |
| 10001 | $5 off on all | 90001 | Jan. 30, | Flat | 5 | 5411 |
| | transactions | | 2016 | | | |
| 10002 | 10% off on all | 90001 | Jan. 30, | Percentage | 10 | 5812 |
| | transactions above | | 2016 | | | |
| | $50 | | | | | |
| 10003 | 15% off on all | 90002 | Mar. | Percentage | 15 | 5691 |
| | transactions above | | 30, 2016 | | | |
| | $99 and take extra | | | | | |
| | 10% next time when | | | | | |
| | you shop | | | | | |
| 10003 | 20% off on all | 90001 | Mar. | Percentage | 20 | 5691 |
| | transactions above | | 30, 2016 | | | |
| | $99 | | | | | |

If Sam uses card 1 then the goods will cost him $80 but if he choose to use card 2 then it will cost him $85. Thus, initially, it may seem that he should do his payment using card 1 as it will give him the best discount.

However, if Sam is going to make a second clothing purchase before Mar. 30, 2016 then using card 2 will give him 10% discount without any minimum purchase limit.

Hence, the Card selection unit 11 may instead suggest Sam to uses Card 2 to make a payment and take the extra benefit of 10% on his next shopping. To decide, the Card selection unit 11 may (in step 107 or 207 of the methods 100, 200) make a prediction of the chance that Sam will want to make a further purchase from the same merchant by Mar. 30, 2016.

For example, if the current transaction date is Mar. 15, 2016 then the Card selection unit 11 may calculate that the chance of Sam doing a second clothing purchase by Mar. 30, 2016 is low. In this case, in steps 109, 209 of the methods 100, 200, the Card selection unit 11 would generate a proposal that Sam uses card 1.

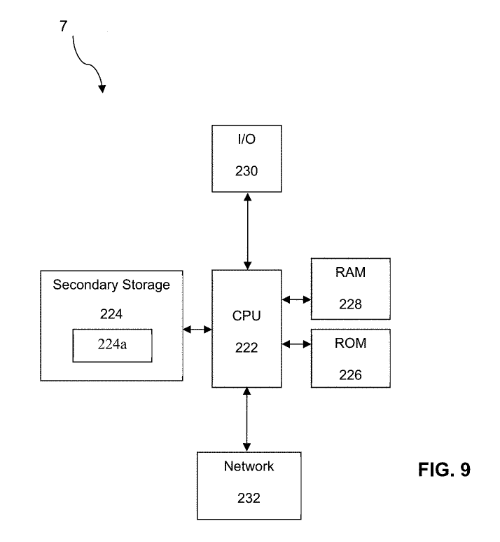

FIG. 9 is a block diagram showing a technical architecture of the digital wallet server 7. The merchant server 6 or the acquirer bank server 12 may also have this technical architecture.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a task processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 9 is a block diagram showing a technical architecture of the communication device 1. It is envisaged that the communication device 1 will be a smartphone or tablet device.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a, a camera 330b and a geolocation module 330c. The UI 330a may comprise a touch screen, keyboard, keypad or other known input device. The camera 330b allows a consumer to capture images and save the captured images in electronic form. The geolocation module 330c is operable to determine the geolocation of the communication device using signals from, for example global positioning system (GPS) satellites. The I/O devices further include a near field communication (NFC) unit 330d, and a controller 330e for the NFC unit 330d. The I/O devices may be supplemented by a host CPU 330f and a secure element (SE) 330g. A secure element is a tamper-resistant platform (typically a one chip secure microcontroller) capable of securely hosting applications and their confidential and cryptographic data.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has a task generation component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present invention.

1. A computer-implemented method for proposing a payment card to be used in a payment transaction to a merchant from a consumer associated with a plurality of payment cards, the method including a computer system:
receiving information characterizing the payment transaction,
identifying the plurality of payment cards associated with the consumer;
accessing at least one consequence database storing information describing consequences of the making payment using the identified payment cards, and thereby deriving consequence data indicative of consequences of using each of the identified payment cards for the payment transaction;
according to the determined consequences, selecting of one of the identified payment cards to use for the payment transaction; and
transmitting data characterizing the selection out of the computer system.

2. A computer-implemented method according to claim 1 in which the data characterizing the selection is transmitted to a communication device associated with a consumer.

3. A computer-implemented method according to claim 1 wherein the consequence database stores information describing, for at least one set of one or more criteria, at least one corresponding offer the merchant makes if the action of using a payment card to make a payment meets the corresponding set of one or more criteria,
the step of determining the consequences of using each of the identified payment cards to make the payment transaction including determining whether using each of the identified payment cards for the payment transaction meets any of the sets of criteria, and if so determining the corresponding at least one offer.

4. A computer-implemented method according to claim 1 wherein the consequence database stores information about loyalty points the consumer would earn in a loyalty program by using a certain payment card,
the step of determining the consequences of using each of the identified payment cards to make the payment transaction, including determining any loyalty points the consumer would thereby earn.

5. A computer-implemented method according to claim 1 wherein the consequence database comprises information about card usage requirements of payment cards,
the step of determining the consequences of using each of the identified payment cards to make the payment transaction, including determining whether using the identified payment cards for the payment transaction assists the consumer to meet usage requirements of the identified payment cards.

6. A computer-implemented method according to claim 1, in which the step of making a selection of one of the payment cards, uses information about the consumer's past transactions.

7. A computer-implemented method according to claim 6 wherein the computer system comprises a model of the consumer's behaviour, the method further including making a probabilistic prediction about the consumer's future payments, the probabilistic prediction being used in calculating the consequences of using at least one of the identified payment cards for the payment transaction.

8. A computer-implemented method according to claim 1 in which the computer system is a digital wallet server implementing a digital wallet, the payment cards associated with the consumer being payment cards registered with the digital wallet.

9. A computer-implemented method according to claim 1 in which a merchant server associated with the merchant transmits data describing the transaction to the computer system.

10. A computer-implemented method according to claim 1 further comprising a communication device associated with the consumer collecting information from a computer device associated with the merchant, and transmitting the collected information to the computer system.

11. A computer-implemented method according to claim 1 in which the computer system is a merchant server associated with the merchant.
upon the consumer accepting the proposal, performing the payment transaction using the selected payment card.

12. A computer system for proposing a payment card to be used in a payment transaction to a merchant from a consumer associated with a plurality of payment cards, the computer system being arranged, upon receiving information characterizing a payment transaction from the consumer,
to identify the plurality of payment cards associated with the consumer;
to access at least one consequence database storing information describing consequences of the making payment using the identified payment cards, and thereby derive consequence data indicative of consequences of using each of the identified payment cards for the payment transaction;
according to the determined consequences, to select of one of the identified payment cards to use for the payment transaction; and
to transmit data characterizing the selection out of the computer system.

13. A computer system according to claim 12 which is operative to transmit the data characterizing the selection is transmitted to a communication device associated with a consumer.

14. A computer system according to claim 12 wherein the consequence database stores information describing, for at least one set of one or more criteria, at least one corresponding offer the merchant makes if the action of using a payment card to make a payment meets the corresponding set of one or more criteria,
the computer system being arranged to determine whether using each of the identified payment cards for the payment transaction meets any of the sets of criteria, and if so determining the corresponding at least one offer.

15. A computer system according to claim 12 wherein the consequence database stores information about loyalty points the consumer would earn in a loyalty program by using a certain payment card,
the computer system being arranged to determine loyalty points the consumer would earn by using each of the identified payment cards to make the payment transaction.

16. A computer system according to claim 12 wherein the consequence database comprises information about card usage requirements of the payment cards,
the computer system being arranged to determine whether using the identified payment cards for the payment transaction assists the consumer to meet usage requirements of the identified payment cards.

17. A computer system according to claim 12 including a component indicative the consumer's past transactions.

18. A computer system according to claim 17 wherein the component is a model of the consumer's behaviour, the computer system being arranged to use the component to make a probabilistic prediction about the consumer's future payments, and to use the probabilistic prediction in calculating the consequences of using at least one of the identified payment cards for the payment transaction.

19. A computer system according to claim 12 which is a digital wallet server implementing a digital wallet, the payment cards associated with the consumer being payment cards registered with the digital wallet.

20. A computer system according to claim 12 which is a merchant server associated with the merchant.

21. A software application for installation on a communication device for operation by a consumer associated with a plurality of payment cards, the software application being operative, when run by a processor of the communication device, to cause the communication device:
to collect information relating to a payment transaction;
to transmit the collected information out of the communication device;
to receive and display to the consumer a recommendation of one of the payment cards to use for the transaction;
to receive a confirmation from the consumer that the recommended payment card is to be used for the transaction; and
upon receiving the confirmation, to transmit a message out of the communication device, whereby the communication device initiates the payment transaction using the recommended payment card.
